(19) United States
(12) Patent Application Publication
(10) Pub. No.: US 2023/0332916 A1
(43) Pub. Date: Oct. 19, 2023

(54) DYNAMIC MAP GENERATION DEVICE, LEARNING DEVICE, DYNAMIC MAP GENERATION METHOD, AND LEARNING METHOD

(71) Applicant: Mitsubishi Electric Corporation, Tokyo (JP)

(72) Inventor: Taiki NAKAURA, Tokyo (JP)

(73) Assignee: Mitsubishi Electric Corporation, Tokyo (JP)

(21) Appl. No.: 18/030,017

(22) PCT Filed: Dec. 4, 2020
(86) PCT No.: PCT/JP2020/045317

§ 371 Date: Apr. 3, 2023

(51) Int. Cl. G01C 21/00; G06N 20/00

(52) U.S. Cl. CPC G01C 21/3804; G06N 20/00

(57) ABSTRACT

A dynamic map generation device includes processing circuitry configured to acquire dynamic map generation information; detect whether or not there is deficient dynamic information or static information in the dynamic map generation information; infer a deficiency-related value on the basis of the dynamic map generation information and a machine learning model when it is detected that there is deficient dynamic information; generate deficiency interpolation information corresponding to the deficient dynamic information on the basis of the deficiency-related value; synchronize the deficiency interpolation information with the dynamic map generation information in which the deficient dynamic information is deficient; and generate the dynamic map on the basis of the synchronized dynamic map generation information.

### TECHNICAL FIELD

The present disclosure relates to a dynamic map generation device, a learning device that generates a learned model used for dynamic map generation, a dynamic map generation method, and a learning method.

### BACKGROUND ART

In recent years, various services using map information have been provided. One of the services is automatic operation using a dynamic map.

The dynamic map is a digital map generated by associating static information such as a high-precision three-dimensional map with dynamic information such as congestion information, surrounding vehicle information, or pedestrian information. A vehicle capable of automatic operation performs automatic operating control while collating information on the dynamic map with information detected by a sensor mounted on the vehicle. Therefore, the content of the dynamic map needs to be close to information detected in the real world.

Meanwhile, for a three-dimensional map used in automatic operation, a technique of detecting inconsistency between the three-dimensional map and a static object in the real world and keeping the three-dimensional map closer to the real world is known (for example, Patent Literature 1).

### CITATION LIST

### Patent Literature

Patent Literature 1: JP 2017-181870 A

### SUMMARY OF INVENTION

### Technical Problem

In the dynamic map, the dynamic information is information having a higher reflection frequency in the dynamic map than the static information, and is information having a large influence on the automatic operation when deficiency of information occurs. However, when the dynamic information is not normally acquired, there is a problem that the dynamic map associated with the dynamic information cannot be generated.

Note that a conventional technique represented by the technique disclosed in Patent Literature 1 is a technique of generating a three-dimensional map in which static information is updated on the basis of information observed in the real world, and update of dynamic information is not considered, and therefore cannot solve the above problem.

The present disclosure has been made in order to solve the above problem, and an object of the present disclosure is to provide a dynamic map generation device capable of generating a dynamic map having dynamic information interpolated even when the dynamic information is not normally acquired.

### Solution to Problem

A dynamic map generation device according to the present disclosure includes: an information acquisition unit that acquires dynamic map generation information including a plurality of types of dynamic information having a high reflection frequency in a dynamic map and a plurality of types of static information having a lower reflection frequency than the dynamic information; a deficiency detection unit that detects whether or not there is deficient dynamic information or static information among the plurality of types of dynamic information or the plurality of types of static information in the dynamic map generation information acquired by the information acquisition unit; an inference unit that infers a deficiency-related value related to deficient dynamic information on the basis of the dynamic map generation information acquired by the information acquisition unit and a machine learning model when the deficiency detection unit detects that there is the deficient dynamic information that is deficient among the plurality of types of dynamic information; an interpolation information generation unit that generates deficiency interpolation information corresponding to the deficient dynamic information on the basis of the deficiency-related value inferred by the inference unit; an information synchronization unit that synchronizes the deficiency interpolation information generated by the interpolation information generation unit with the dynamic map generation information in which the deficient dynamic information is deficient; and a dynamic map generation unit that generates the dynamic map on the basis of the dynamic map generation information synchronized by the information synchronization unit.

### Advantageous Effects of Invention

According to the present disclosure, even when dynamic information is not normally acquired, a dynamic map having the dynamic information interpolated can be generated.

### BRIEF DESCRIPTION OF DRAWINGS

FIG. 1 is a diagram illustrating a configuration example of a dynamic map generation device according to a first embodiment.

FIG. 2 is a diagram illustrating an example of a dynamic map generated by a dynamic map generation device in the first embodiment.

FIG. 3 is a table for explaining an example of the content of dynamic map generation information acquired by an information acquisition unit in the first embodiment, in which FIG. 3A illustrates a specific example of the content of dynamic map generation information acquired by the information acquisition unit from a control center, FIG. 3B illustrates a specific example of the content of dynamic map generation information acquired by the information acquisition unit from a web server, and FIG. 3C illustrates a specific example of the content of dynamic map generation information acquired by the information acquisition unit from a sensor.

FIG. 4 is a diagram for explaining an example of correlation dynamic information or correlation static information determined depending on the type of deficient dynamic information in the first embodiment.

FIG. 5 is a diagram for explaining an example of a deficiency-related value inferred by an inference unit in the first embodiment.

FIG. 6 is a diagram illustrating an example of a dynamic map generated by a dynamic map generation unit in the first embodiment.

FIG. 7 is a flowchart for explaining an operation of the dynamic map generation device according to the first embodiment.

FIGS. 8A and 8B are each a diagram illustrating an example of a hardware configuration of the dynamic map generation device according to the first embodiment.

FIG. 9 is a diagram for explaining an example of learning data generated by a learning data generation unit in the first embodiment.

FIG. 10 is a flowchart for explaining an operation of a learning device according to the first embodiment.

FIG. 11 is a diagram illustrating a configuration example of a dynamic map generation device on which a learning device is mounted in the first embodiment.

### DESCRIPTION OF EMBODIMENTS

Hereinafter, an embodiment of the present disclosure will be described in detail with reference to the drawings.

### First Embodiment

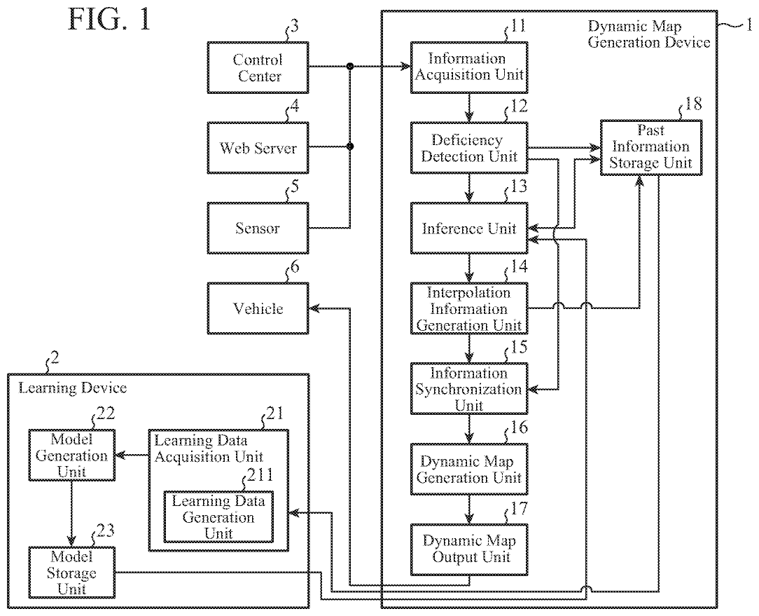

FIG. 1 is a diagram illustrating a configuration example of a dynamic map generation device 1 according to a first embodiment.

The dynamic map generation device 1 according to the first embodiment is mounted on a server or a cloud. Here, it is assumed that the dynamic map generation device 1 is mounted on a server.

The dynamic map generation device 1 acquires information for generating a dynamic map (hereinafter, referred to as “dynamic map generation information”) from a control center 3, a web server 4, and a sensor 5, and generates the dynamic map. Note that, in the first embodiment, it is assumed that the dynamic map is already present and is stored in a place that can be referred to by the dynamic map generation device 1. In the first embodiment, generation of the dynamic map by the dynamic map generation device 1 means updating the content of the dynamic map that is already present.

The dynamic map generation device 1 outputs the generated dynamic map to a vehicle 6.

Here, first, the dynamic map will be described.

The dynamic map is a digital map generated by associating various pieces of information regarding road traffic such as information of surrounding vehicles or traffic information in real time with a high-precision three-dimensional map on which a host vehicle can specify the position of the host vehicle related to a road or surroundings of the road at a lane level.

The dynamic map is used in automatic operation. Specifically, a vehicle capable of automatic operation (hereinafter, referred to as “automatic operating vehicle”) performs automatic operating control, for example, while collating information on the dynamic map with information acquired from a sensor mounted on the automatic operating vehicle. By travelling while collating various pieces of information associated in real time on the dynamic map with the information acquired from the sensor, the automatic operating vehicle can accurately identify the position of the host vehicle or can immediately detect an obstacle or the like, and can smoothly travel on the basis of prediction. Note that the vehicle 6 is assumed to be an automatic operating vehicle.

The dynamic map includes static information, semi-static information, semi-dynamic information, and dynamic information. That is, the dynamic map generation information includes static information, semi-static information, semi-dynamic information, and dynamic information.

The static information is high-precision three-dimensional map information. The high-precision three-dimensional map information includes road surface information, lane information, building position information, and the like.

The semi-static information includes information regarding a schedule of traffic regulations, information regarding a schedule of road construction, wide area weather forecast information, and the like.

The semi-dynamic information includes accident information, congestion information, traffic regulation information, road construction information, narrow area weather forecast information, and the like.

The dynamic information includes surrounding vehicle information, pedestrian information, signal information, and the like.

The dynamic map is generated by associating semi-static information, semi-dynamic information, and dynamic information with high-precision three-dimensional map information that is static information. Note that an association rule for associating the semi-static information, the semi-dynamic information, and the dynamic information with the high-precision three-dimensional map information is preset.

In the following first embodiment, the dynamic information and the semi-dynamic information as described above are collectively referred to as “dynamic information”, and the static information and the semi-static information as described above are collectively referred to as “static information”. Note that, as described above, there is a plurality of types of dynamic information such as congestion information and surrounding vehicle information. In the first embodiment, the plurality of types of dynamic information is also simply referred to as “dynamic information”. In addition, there is a plurality of types of static information such as high-precision three-dimensional map information and information regarding a schedule of traffic regulations. In the first embodiment, the plurality of types of static information is also simply referred to as “static information”.

The dynamic information has a high reflection frequency in the dynamic map. The reflection frequency of the dynamic information is very high, such as once a second. That is, the dynamic information is information that needs to be reflected in real time in the dynamic map, and deficiency of the dynamic information has a large influence. For example, when the dynamic information is not normally acquired, the dynamic information is not reflected in the dynamic map. When the dynamic information is not reflected in the dynamic map, for example, the automatic operating vehicle cannot acquire information of a pedestrian or the like in a blind spot from a sensor mounted on the host vehicle and cannot perform correct automatic operating control.

Meanwhile, the static information has a lower reflection frequency in the dynamic map than the dynamic information. The reflection frequency of the static information is very low, such as once a day. That is, the static information is information whose deficiency can be coped with by retransmission even if the deficiency occurs, and the deficiency of the static information has a small influence. For example, even if a schedule of traffic regulations is not reflected in the dynamic map, the automatic operating vehicle can perform automatic operating control on the basis of information acquired from the sensor.

In consideration of the above-described problems, the dynamic map generation device 1 according to the first embodiment generates a dynamic map having dynamic information interpolated even when the dynamic information is not normally acquired. As a result, the dynamic map generation device 1 supports automatic operating control by the automatic operating vehicle.

Note that, as described above, in the dynamic map, the timing at which the static information is reflected in the dynamic map is different from the timing at which the dynamic information is reflected in the dynamic map.

The dynamic map generation device 1 generates a dynamic map reflecting the static information or the dynamic information at a predetermined reflection timing of the static information and a predetermined reflection timing of the dynamic information. That is, the dynamic map generation device 1 updates the dynamic map at a predetermined reflection timing of the static information and a predetermined reflection timing of the dynamic information. The dynamic map generation device 1 outputs the generated dynamic map to the automatic operating vehicle each time the dynamic map is generated.

In the first embodiment, the dynamic map generation device 1 will be described assuming that the reflection timing of the dynamic information has come.

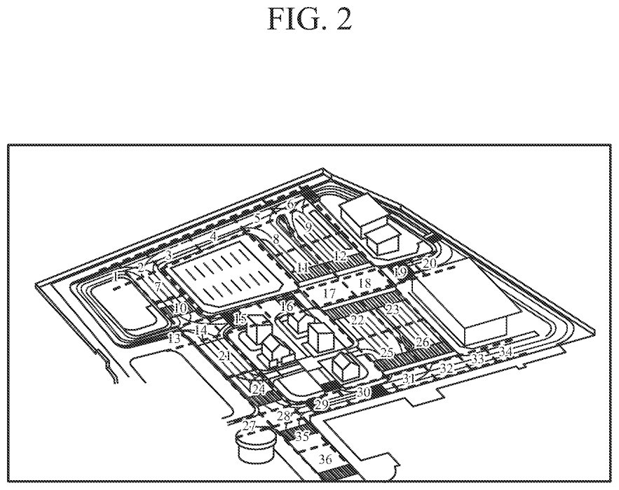

Here, FIG. 2 is a diagram illustrating an example of a dynamic map generated by the dynamic map generation device 1 in the first embodiment.

As illustrated in FIG. 2, in the dynamic map, a region in which dynamic information needs to be reflected is divided into a plurality of areas in advance.

In FIG. 2, as an example, a first area to a 36th area are set in the dynamic map.

In the first embodiment, the dynamic map generation device 1 generates a dynamic map for each area.

Return to the description of FIG. 1.

As illustrated in FIG. 1, the dynamic map generation device 1 is connected to the learning device 2, the control center 3, the web server 4, the sensor 5, and the vehicle 6 via a network.

The learning device 2 generates a learned model used when the dynamic map generation device 1 generates a dynamic map (hereinafter, referred to as “machine learning model”).

It is assumed that the learning device 2 is mounted on a server different from the server of the dynamic map generation device 1. Details of the learning device 2 will be described later.

The control center 3 outputs all pieces of information regarding a road to the dynamic map generation device 1. The information output from the control center 3 to the dynamic map generation device 1 includes high-precision three-dimensional map information including road surface information, lane information, building position information, and the like, in other words, static information.

The web server 4 is a web server included in a traffic information system (not illustrated), a web server included in a weather information system (not illustrated), or the like, and outputs information regarding traffic and information regarding weather to the dynamic map generation device 1. The information output from the web server 4 to the dynamic map generation device 1 includes static information such as information regarding a schedule of traffic regulations, information regarding a schedule of road construction, and wide area weather forecast information, and dynamic information such as accident information, congestion information, traffic regulation information, road construction information, and narrow area weather forecast information.

Note that although only one web server 4 is illustrated in FIG. 1, the number of web servers 4 is not limited to one. A plurality of web servers 4 can be connected to the dynamic map generation device 1.

The sensor 5 is a sensor disposed on a road shoulder or a sensor mounted on a vehicle, and outputs information regarding the surroundings of a road and information regarding the surroundings of the vehicle to the dynamic map generation device 1. The information output from the sensor 5 to the dynamic map generation device 1 includes dynamic information such as surrounding vehicle information, pedestrian information, signal information, and risk information. In the first embodiment, the risk information is information of a degree of risk indicating a possibility that the vehicle falls into an unexpected situation.

Although only one sensor 5 is illustrated in FIG. 1, a plurality of sensors 5 is connected to the dynamic map generation device 1.

The vehicle 6 is an automatic operating vehicle, and performs automatic operating control using a dynamic map output from the dynamic map generation device 1.

Although only one vehicle 6 is illustrated in FIG. 1, the number of vehicles 6 is not limited to one. A plurality of vehicles 6 can be connected to the dynamic map generation device 1.

As illustrated in FIG. 1, the dynamic map generation device 1 includes an information acquisition unit 11, a deficiency detection unit 12, an inference unit 13, an interpolation information generation unit 14, an information synchronization unit 15, a dynamic map generation unit 16, a dynamic map output unit 17, and a past information storage unit 18.

The information acquisition unit 11 acquires dynamic map generation information from the control center 3, the web server 4, and the sensor 5 via a communication unit (not illustrated) that performs communication according to a standard such as 5th Generation (5G) or Long Term Evolution (LTE). Specifically, the information acquisition unit 11 extracts dynamic map generation information from information output from each of the control center 3, the web server 4, and the sensor 5, and acquires the dynamic map generation information.

For example, the information acquisition unit 11 extracts road surface information, lane information, and building position information from all pieces of information regarding a road output from the control center 3, and acquires the information as the dynamic map generation information.

In addition, for example, the information acquisition unit 11 extracts information regarding a schedule of traffic regulations, information regarding a schedule of road construction, wide area weather forecast information, accident information, congestion information, traffic regulation information, road construction information, and narrow area weather forecast information from information regarding traffic and information regarding weather output from the web server 4, and acquires the information as the dynamic map generation information.

In addition, for example, the information acquisition unit 11 extracts surrounding vehicle information, pedestrian information, signal information, and risk information from information regarding the surroundings of a road or information regarding the surroundings of the vehicle output from the sensor 5, and acquires the information as the dynamic map generation information.

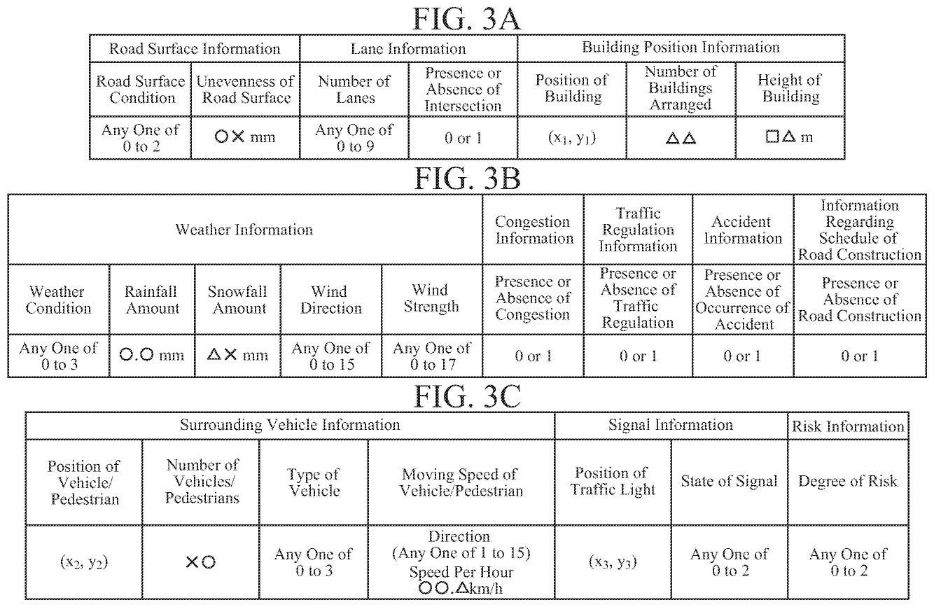

FIG. 3 is a diagram for explaining an example of the content of the dynamic map generation information acquired by the information acquisition unit 11 in the first embodiment.

FIG. 3A illustrates a specific example of the content of dynamic map generation information acquired by the information acquisition unit 11 from the control center 3, FIG. 3B illustrates a specific example of the content of dynamic map generation information acquired by the information acquisition unit 11 from the web server 4, and FIG. 3C illustrates a specific example of the content of dynamic map generation information acquired by the information acquisition unit 11 from the sensor 5.

As illustrated in FIG. 3A, the road surface information includes, for example, information regarding a road surface condition and information regarding road surface unevenness. The road surface condition is represented by, for example, “0: dry”, “1: wet”, or “2: frozen”. The road surface unevenness is represented by, for example, an unevenness width. The lane information includes, for example, information regarding the number of lanes and presence or absence of an intersection. The number of lanes is represented by a numerical value of 0 to 9, and the presence or absence of an intersection is represented by “0: present” or “1: absent”. The building position information includes, for example, information regarding the position of a building, the number of buildings arranged, and information regarding the height of a building. The position of a building is represented by a world coordinate system. The number of buildings arranged is represented by an integer value. The height of a building is represented by a value expressing a Z coordinate of a world coordinate system indicating the position of the building in units of m.

As illustrated in FIG. 3B, the weather information including wide area weather forecast information and narrow area weather forecast information includes, for example, information regarding a weather condition, information regarding a rainfall amount, a snowfall amount, and a wind direction, or information regarding a wind strength. The information regarding a weather condition is represented by, for example, “0: sunny”, “1: cloudy”, “2: rainy”, or “3: snowy”. The rainfall amount and the snowfall amount are expressed, for example, in units of mm. The information about regarding a wind direction is represented by, for example, a value obtained by defining 16 direction as 0 to 15. The information regarding a wind strength is represented by, for example, a value of 0 to 17.

The congestion information, the traffic regulation information, the accident information, and the information regarding a schedule of road construction are represented by, for example, “0: present” or “1: absent.”

As illustrated in FIG. 3C, the surrounding vehicle information includes, for example, information regarding the position of a vehicle, information regarding the number of vehicles and the type of vehicle, or information regarding a moving speed of the vehicle. The information regarding the position of a vehicle is represented by, for example, a world coordinate system. The number of vehicles is represented by, for example, an integer value. The type of vehicle is represented by, for example, “0: standard-size vehicle”, “1: light vehicle”, “2: truck”, or “3: others”. The moving speed of a vehicle is represented by, for example, a direction in 16 directions (value of 0 to 15) and a speed per hour. The pedestrian information is represented by, for example, a method similar to that of the surrounding vehicle information. In FIG. 3C, surrounding vehicle information and pedestrian information are collectively illustrated. Note that the pedestrian information does not include information regarding the type of pedestrian. The signal information includes, for example, information regarding the position of a traffic light or information regarding a state of a signal. The information regarding the position of a traffic light is represented by, for example, a world coordinate system. The information regarding a state of a signal is represented by, for example, “0: green”, “1: yellow”, or “2: red”. The risk information is represented by, for example, a degree of risk “0: high”, a degree of risk “1: medium”, or a degree of risk “2: low”.

The information acquisition unit 11 outputs the acquired dynamic map generation information to the deficiency detection unit 12. The information acquisition unit 11 outputs the dynamic map generation information to the deficiency detection unit 12 in association with information regarding the date and time when the dynamic map generation information has been acquired.

Note that cycles at which information is output from the control center 3, the web server 4, and the sensor 5 may be different from each other. For example, every time information is output from the control center 3, the web server 4, or the sensor 5, the information acquisition unit 11 only needs to acquire the dynamic map generation information from the information output from the control center 3, the web server 4, or the sensor 5.

The deficiency detection unit 12 detects whether or not there is deficient dynamic information or static information among pieces of dynamic information or pieces of static information in the dynamic map generation information acquired by the information acquisition unit 11.

Specifically, the deficiency detection unit 12 detects whether or not there is information that has not been normally acquired among the pieces of dynamic information or the pieces of static information. More specifically, the deficiency detection unit 12 detects whether or not there is information that has not been acquired within a preset period (hereinafter, referred to as “deficiency determination period”) among the pieces of dynamic information or the pieces of static information. When the dynamic information or the static information has not been acquired within the deficiency determination period, the deficiency detection unit 12 detects that the dynamic information or the static information has not been normally acquired. Note that types of dynamic information and static information to be included in the dynamic map generation information are predetermined. If there is information that has not been acquired within the deficiency determination period among the predetermined types of dynamic information and static information, the deficiency detection unit 12 only needs to detect that the information has not been normally acquired.

As described above, cycles at which information is output from the control center 3, the web server 4, and the sensor 5 may be different from each other. That is, cycles at which the information acquisition unit 11 acquires the dynamic information and the static information may be different from each other.

Therefore, there may be dynamic information or static information not included in the dynamic map generation information that has been just output from the information acquisition unit 11 because it is not the cycle at which the information is output. For example, the deficiency detection unit 12 temporarily stores the dynamic map generation information acquired from the information acquisition unit 11 for a certain period, and detects whether or not dynamic information or static information has been acquired within the deficiency determination period on the basis of the temporarily stored dynamic map generation information.

Note that a deficiency determination period for detecting deficiency of dynamic information (hereinafter, referred to as “first deficiency determination period”) is different from a deficiency determination period for detecting deficiency of static information (hereinafter, referred to as “second deficiency determination period”). The first deficiency determination period is shorter than the second deficiency determination period. This is because the dynamic information has a higher reflection frequency in the dynamic map than the static information. The first deficiency determination period may be further divided into a deficiency determination period for dynamic information and a deficiency determination period for semi-dynamic information. The second deficiency determination period may be further divided into a deficiency determination period for static information and a deficiency determination period for semi-static information.

As a result of detecting whether or not there is deficient dynamic information or static information among pieces of dynamic information or pieces of static information in the dynamic map generation information, if the deficiency detection unit 12 detects that there is deficient dynamic information or static information, and the deficient information is dynamic information, the deficiency detection unit 12 outputs information indicating that deficiency occurs in the dynamic information (hereinafter, referred to as “dynamic deficiency detection information”) to the inference unit 13. The dynamic deficiency detection information includes the dynamic map generation information acquired by the information acquisition unit 11. In the first embodiment, the dynamic information in which deficiency occurs is also referred to as “deficient dynamic information”.

As a cause of occurrence of deficiency in the dynamic information, that is, a cause why the dynamic information is not normally acquired, for example, a communication delay between the dynamic map generation device 1 and the web server 4 or the sensor 5 can be considered.

If the deficiency detection unit 12 detects that there is deficient dynamic information or static information, and the deficient information is static information, the deficiency detection unit 12 outputs information requesting re-output of information to an output source of the deficient static information via the communication unit. Note that output sources of the dynamic information and the static information are known in advance.

Meanwhile, if the deficiency detection unit 12 detects that the dynamic information or the static information is not deficient in the dynamic map generation information, the deficiency detection unit 12 stores the dynamic map generation information acquired by the information acquisition unit 11 in the past information storage unit 18 in association with the acquisition date and time of the dynamic map generation information, and outputs the dynamic map generation information to the information synchronization unit 15. The past information storage unit 18 stores the information which is illustrated as an example in FIGS. 3A, 3B, and 3C in association with the acquisition date and time.

Note that, at this time, the deficiency detection unit 12 fills dynamic information or static information, which has been just detected not to be included in the dynamic map generation information output from the information acquisition unit 11 because it is not the cycle at which the information is output as described above, with the latest dynamic information or static information, for example, on the basis of the temporarily stored dynamic map generation information.

When the dynamic deficiency detection information is output from the deficiency detection unit 12, in other words, when the deficiency detection unit 12 detects that there is deficient dynamic information in the dynamic information, the inference unit 13 infers a value related to the deficient dynamic information (hereinafter, referred to as “deficiency-related value”) on the basis of the dynamic map generation information acquired by the information acquisition unit 11 and a machine learning model.

Specifically, the inference unit 13 infers the deficiency-related value related to the deficient dynamic information on the basis of dynamic information (hereinafter, referred to as “correlation dynamic information”) or static information (hereinafter, referred to as “correlation static information”) correlated with the deficient dynamic information among the pieces of dynamic information and the pieces of static information included in the dynamic map generation information acquired by the information acquisition unit 11 within a preset period (hereinafter, referred to as “inference period”), the dynamic information of the same type as the deficient dynamic information included in the dynamic map generation information acquired by the information acquisition unit 11 within the inference period (hereinafter, referred to as “dynamic history information”), and the machine learning model.

The inference unit 13 acquires the correlation dynamic information or the correlation static information acquired by the information acquisition unit 11 within the inference period from the past information storage unit 18. In addition, the inference unit 13 acquires the dynamic history information acquired by the information acquisition unit 11 within the inference period from the past information storage unit 18.

Note that, in the first embodiment, it is assumed that the dynamic map generation device 1 operates in a state where a certain amount of dynamic map generation information is stored in the past information storage unit 18.

In the first embodiment, the machine learning model is a machine learning model that receives, as inputs, the correlation dynamic information or the correlation static information among the pieces of dynamic information and the pieces of static information included in the dynamic map generation information acquired by the information acquisition unit 11 within the inference period, and the dynamic history information acquired by the information acquisition unit 11 within the inference period, and outputs a deficiency-related value related to the deficient dynamic information. The machine learning model is generated by the learning device 2 and stored in a model storage unit 23. Details of the learning device 2 will be described later.

Here, the correlation dynamic information and the correlation static information will be described.

The correlation dynamic information and the correlation static information are predetermined depending on the type of deficient dynamic information.

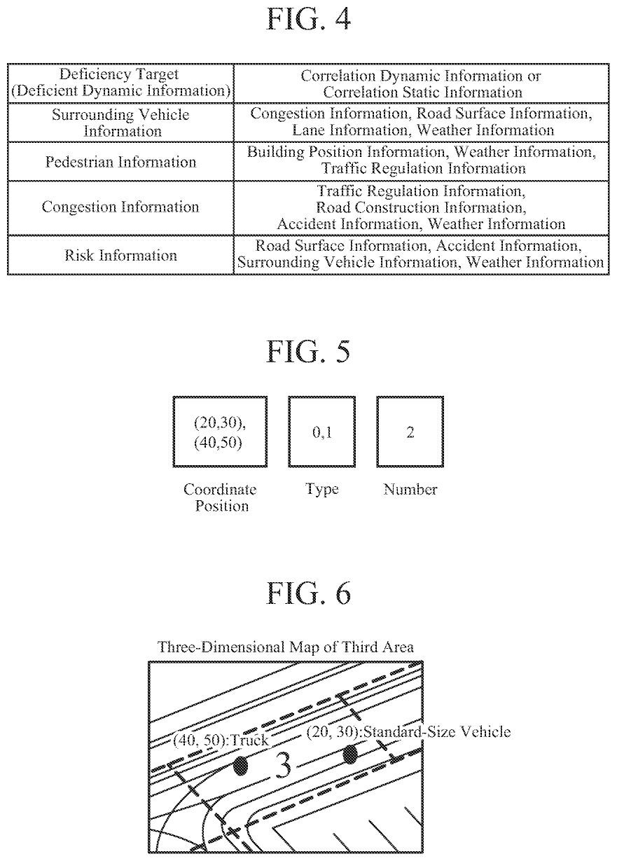

FIG. 4 is a diagram for explaining an example of correlation dynamic information or correlation static information determined depending on the type of deficient dynamic information in the first embodiment.

For example, when the deficient dynamic information is surrounding vehicle information, the correlation dynamic information or the correlation static information is determined to be congestion information, road surface information, lane information, and weather information.

The inference unit 13 acquires corresponding correlation dynamic information or correlation static information and dynamic history information depending on the type of deficient dynamic information. Then, the inference unit 13 receives the acquired correlation dynamic information or correlation static information and dynamic history information as inputs of the machine learning model, and obtains a deficiency-related value of the deficient dynamic information.

Note that the learning device 2 generates a machine learning model corresponding to the deficient dynamic information, in other words, a machine learning model corresponding to input information (correlation dynamic information or correlation static information and dynamic history information).

For example, it is now assumed that the dynamic map generation device 1 generates a dynamic map of a third area (see FIG. 2), and the deficiency detection unit 12 detects that the surrounding vehicle information is deficient dynamic information.

In this case, the inference unit 13 infers a deficiency-related value of the surrounding vehicle information on the basis of the congestion information, the road surface information, the lane information, and the weather information acquired within the inference period, the surrounding vehicle information acquired within the inference period, and the machine learning model.

FIG. 5 is a diagram for explaining an example of a deficiency-related value inferred by the inference unit 13 in the first embodiment.

FIG. 5 is an example of the deficiency-related value of the surrounding vehicle information inferred by the inference unit 13 in the above example.

For example, as illustrated in FIG. 5, the inference unit 13 infers, as the deficiency-related values of the surrounding vehicle information, deficiency-related values in which a coordinate position, the type of vehicle, and the number of vehicles are converted into numerical values and associated with each other.

In FIG. 5, the inference unit 13 indicates a result obtained by inferring the coordinate positions “(20, 30) and (40, 50)” of vehicles, the types of the vehicles “0 and 1”, and the number of the vehicles “2”.

The inference unit 13 outputs the inferred deficiency-related value to the interpolation information generation unit 14. Note that the inference unit 13 outputs the deficiency-related value to the interpolation information generation unit 14 in association with information that can specify the deficient dynamic information.

The interpolation information generation unit 14 generates deficiency interpolation information on the basis of the deficiency-related value of the deficient dynamic information inferred by the inference unit 13. In the first embodiment, the deficiency interpolation information is information for interpolating deficient dynamic information, corresponding to the deficient dynamic information in the dynamic map generation information when the dynamic map generation device 1 generates a dynamic map.

Specifically, the interpolation information generation unit 14 converts the deficiency-related value into information in a map format. Note that it is assumed that a conversion rule from the deficiency-related value to a map format is preset.

For example, as illustrated in FIG. 5, it is assumed that the inference unit 13 infers the coordinate positions of vehicles “(20, 30) and (40, 50)”, the type of vehicles “0 and 1”, and the number of vehicles “2” as the deficiency-related values of the surrounding vehicle information. In this case, for example, in the third area of the dynamic map, the interpolation information generation unit 14 generates deficiency interpolation information indicating that there are two vehicles in total including a standard-size vehicle at the point (20, 30) and a truck at the point (40, 50).

The interpolation information generation unit 14 outputs the generated deficiency interpolation information to the information synchronization unit 15.

In addition, the interpolation information generation unit 14 adds the deficiency-related value inferred by the inference unit 13 instead of deficient dynamic information in the dynamic map generation information in which the deficient dynamic information is deficient, and stores the dynamic map generation information after addition of the deficiency-related value in the past information storage unit 18.

When storing the dynamic map generation information in the past information storage unit 18, the interpolation information generation unit 14 adds information indicating a deficiency-related value (hereinafter, referred to as “interpolation flag”) to the deficiency-related value.

The information synchronization unit 15 synchronizes the deficiency interpolation information generated by the interpolation information generation unit 14 with the dynamic map generation information in which the deficient dynamic information is deficient, acquired by the information acquisition unit 11. Specifically, the information synchronization unit 15 converts dynamic information and static information other than the deficient dynamic information among the pieces of dynamic information and the pieces of static information included in the dynamic map generation information acquired by the information acquisition unit 11 into information in a map format. This operation is similar to an operation when the interpolation information generation unit 14 generates deficiency interpolation information. Then, the information synchronization unit 15 outputs information obtained by associating the dynamic information and the static information other than the deficient dynamic information after conversion with the deficiency interpolation information (hereinafter, referred to as “post-synchronization dynamic map generation information”) to the dynamic map generation unit 16.

For example, in the above example, assuming that the dynamic map generation information in which surrounding vehicle information is deficient includes information regarding a road surface condition indicating wetness and information regarding a weather condition indicating rain, the information synchronization unit 15 synchronizes the information indicating that there are two vehicles in total including a standard-size vehicle at the point (20, 30) and a truck at the point (40, 50) in the third area with the information indicating that a road surface is wet and it is raining in the third area.

Note that, when the dynamic map generation information that has been detected to have no deficiency is output from the deficiency detection unit 12, the information synchronization unit 15 converts the dynamic information and the static information included in the dynamic map generation information into information in a map format, and outputs the converted dynamic map generation information to the dynamic map generation unit 16 as the post-synchronization dynamic map generation information.

The dynamic map generation unit 16 generates a dynamic map on the basis of the post-synchronization dynamic map generation information output from the information synchronization unit 15.

In the above example, the dynamic map generation unit 16 generates, for example, a dynamic map of the third area reflecting a state in which there are two vehicles in total including a standard-size vehicle at the point (20, 30) and a truck at the point (40, 50), a road surface is wet, and it is raining. In other words, the dynamic map generation unit 16 updates the dynamic map of the third area to a state in which there are two vehicles in total including a standard-size vehicle at the point (20, 30) and a truck at the point (40, 50), a road surface is wet, and it is raining.

FIG. 6 is a diagram illustrating an example of a dynamic map generated by the dynamic map generation unit 16 in the first embodiment.

Note that, in FIG. 6, for convenience, only the standard-size vehicle and the truck are reflected on the high-precision three-dimensional map, and each of the standard-size vehicle and the truck is indicated by a coordinate and a black circle.

The dynamic map generation unit 16 outputs the generated dynamic map to the dynamic map output unit 17.

The dynamic map output unit 17 outputs the dynamic map generated by the dynamic map generation unit 16 to the vehicle 6 via the communication unit.

The past information storage unit 18 stores dynamic map generation information.

Note that, in the first embodiment, the past information storage unit 18 is included in the dynamic map generation device 1, but this is merely an example. The past information storage unit 18 may be disposed in a place that can be referred to by the dynamic map generation device 1 outside the dynamic map generation device 1.

An operation of the dynamic map generation device 1 according to the first embodiment will be described.

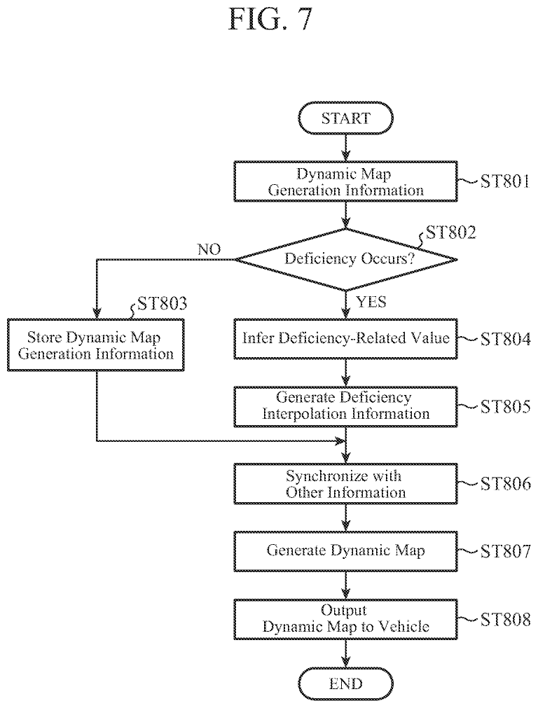

FIG. 7 is a flowchart for explaining the operation of the dynamic map generation device 1 according to the first embodiment.

The information acquisition unit 11 acquires dynamic map generation information from the control center 3, the web server 4, and the sensor 5 via the communication unit (step ST801). Specifically, the information acquisition unit 11 extracts dynamic map generation information from information output from each of the control center 3, the web server 4, and the sensor 5, and acquires the dynamic map generation information.

The information acquisition unit 11 outputs the acquired dynamic map generation information to the deficiency detection unit 12.

The deficiency detection unit 12 detects whether or not there is deficient dynamic information or static information among pieces of dynamic information or pieces of static information in the dynamic map generation information acquired in step ST801 by the information acquisition unit 11 (step ST802).

As a result of detecting whether or not there is deficient dynamic information or static information among pieces of dynamic information or pieces of static information in the dynamic map generation information, when the deficiency detection unit 12 detects that there is deficient dynamic information or static information, and the deficient information is dynamic information (if “YES” in step ST802), the deficiency detection unit 12 outputs dynamic deficiency detection information to the inference unit 13.

If the deficiency detection unit 12 detects that there is deficient dynamic information or static information, and the deficient information is static information, the deficiency detection unit 12 outputs information requesting re-output of information to an output source of the deficient static information via the communication unit.

Meanwhile, if the deficiency detection unit 12 detects that the dynamic information or the static information is not deficient in the dynamic map generation information (if “NO” in step ST802), the deficiency detection unit 12 stores the dynamic map generation information acquired in step ST801 by the information acquisition unit 11 in the past information storage unit 18 in association with the acquisition date and time of the dynamic map generation information (step ST803).

The inference unit 13 infers a deficiency-related value of the deficient dynamic information on the basis of the dynamic map generation information acquired in step ST801 by the information acquisition unit 11 and a machine learning model (step ST804).

The inference unit 13 outputs the inferred deficiency-related value of the deficient dynamic information to the interpolation information generation unit 14.

The interpolation information generation unit 14 generates deficiency interpolation information on the basis of the deficiency-related value inferred in step ST804 by the inference unit 13 (step ST805).

The interpolation information generation unit 14 outputs the generated deficiency interpolation information to the information synchronization unit 15.

In addition, the interpolation information generation unit 14 adds the deficiency-related value inferred by the inference unit 13 instead of deficient dynamic information in the dynamic map generation information in which the deficient dynamic information is deficient, and stores the dynamic map generation information after addition of the deficiency-related value in the past information storage unit 18.

The information synchronization unit 15 synchronizes the deficiency interpolation information generated in step ST805 by the interpolation information generation unit 14 with the dynamic map generation information in which the deficient dynamic information is deficient, acquired by the information acquisition unit 11 (step ST806).

The information synchronization unit 15 outputs the post-synchronization dynamic map generation information to the dynamic map generation unit 16 and stores the post-synchronization dynamic map generation information in the past information storage unit 18.

The dynamic map generation unit 16 generates a dynamic map on the basis of the post-synchronization dynamic map generation information output in step ST806 from the information synchronization unit 15 (step ST807).

The dynamic map generation unit 16 outputs the generated dynamic map to the dynamic map output unit 17.

The dynamic map output unit 17 outputs the dynamic map generated in step ST807 by the dynamic map generation unit 16 to the vehicle 6 via the communication unit (step ST808).

As described above, the dynamic map generation device 1 detects whether or not there is deficient dynamic information or static information among pieces of dynamic information or pieces of static information in the acquired dynamic map generation information, and if the dynamic map generation device 1 detects that there is deficient dynamic information in the dynamic information, the dynamic map generation device 1 infers a deficiency-related value of the deficient dynamic information on the basis of the dynamic map generation information and a machine learning model. Then, the dynamic map generation device 1 generates deficiency interpolation information on the basis of the inferred deficiency-related value, synchronizes the deficiency interpolation information with the dynamic map generation information in which the deficient dynamic information is deficient, and generates a dynamic map on the basis of the post-synchronization dynamic map generation information. As a result, even when dynamic information is not normally acquired, the dynamic map generation device 1 can generate a dynamic map having the dynamic information interpolated.

The dynamic map generation device 1 estimates a deficiency-related value using a machine learning model. Since the machine learning model is a model that receives correlation dynamic information or correlation static information having various combinations as inputs of the machine learning model, and outputs a deficiency-related value, the dynamic map generation device 1 can estimate various deficiency-related values. In addition, since the dynamic map generation device 1 estimates a deficiency-related value on the basis of the correlation dynamic information or the correlation static information in addition to a past history of the deficient dynamic information, for example, the dynamic map generation device 1 can estimate the deficiency-related value more accurately than estimating the deficiency-related value simply from the past history of the deficient dynamic information.

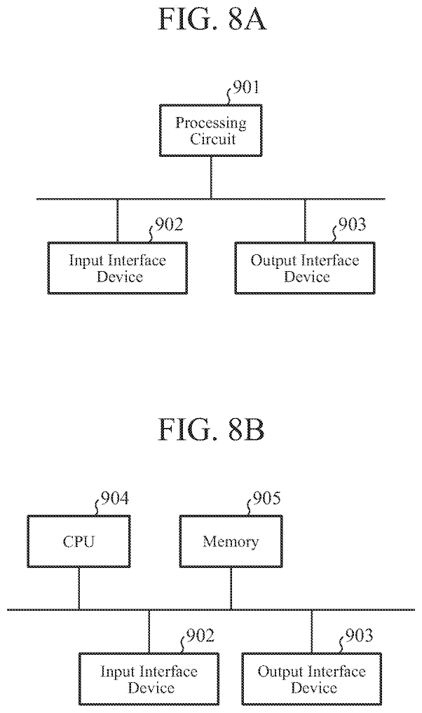

FIGS. 8A and 8B are each a diagram illustrating an example of a hardware configuration of the dynamic map generation device 1 according to the first embodiment.

In the first embodiment, functions of the information acquisition unit 11, the deficiency detection unit 12, the inference unit 13, the interpolation information generation unit 14, the information synchronization unit 15, the dynamic map generation unit 16, and the dynamic map output unit 17 are implemented by a processing circuit 901. That is, the dynamic map generation device 1 includes the processing circuit 901 for performing control to generate a dynamic map on the basis of the acquired dynamic map generation information.

The processing circuit 901 may be dedicated hardware as illustrated in FIG. 8A or a central processing unit (CPU) 904 that executes a program stored in a memory 905 as illustrated in FIG. 8B.

When the processing circuit 901 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 901.

In a case where the processing circuit 901 is the CPU 904, functions of the information acquisition unit 11, the deficiency detection unit 12, the inference unit 13, the interpolation information generation unit 14, the information synchronization unit 15, the dynamic map generation unit 16, and the dynamic map output unit 17 are implemented by software, firmware, or a combination of software and firmware. The software or firmware is described as a program and stored in the memory 905. By reading and executing a program stored in the memory 905, the processing circuit 901 executes the functions of the information acquisition unit 11, the deficiency detection unit 12, the inference unit 13, the interpolation information generation unit 14, the information synchronization unit 15, the dynamic map generation unit 16, and the dynamic map output unit 17. That is, the dynamic map generation device 1 includes the memory 905 for storing a program that causes steps ST801 to ST808 illustrated in FIG. 7 described above to be executed as a result when the program is executed by the processing circuit 901. It can also be said that the program stored in the memory 905 causes a computer to execute procedures or methods performed by the information acquisition unit 11, the deficiency detection unit 12, the inference unit 13, the interpolation information generation unit 14, the information synchronization unit 15, the dynamic map generation unit 16, and the dynamic map output unit 17. Here, for example, a nonvolatile or volatile semiconductor memory such as a RAM, read only memory (ROM), flash memory, erasable programmable read only memory (EPROM), or electrically erasable programmable read-only memory (EEPROM), a magnetic disk, a flexible disk, an optical disc, a compact disc, a mini disc, or a digital versatile disc (DVD) corresponds to the memory 905.

Note that some of the functions of the information acquisition unit 11, the deficiency detection unit 12, the inference unit 13, the interpolation information generation unit 14, the information synchronization unit 15, the dynamic map generation unit 16, and the dynamic map output unit 17 may be implemented by dedicated hardware, and some of the functions may be implemented by software or firmware. For example, the functions of the information acquisition unit 11 and the dynamic map output unit 17 can be implemented by the processing circuit 901 as dedicated hardware, and the functions of the deficiency detection unit 12, the inference unit 13, the interpolation information generation unit 14, the information synchronization unit 15, and the dynamic map generation unit 16 can be implemented by the processing circuit 901 reading and executing a program stored in the memory 905.

In addition, the past information storage unit 18 uses the memory 905. Note that this is an example, and the past information storage unit 18 may be constituted by an HDD, a solid state drive (SSD), a DVD, or the like.

In addition, the dynamic map generation device 1 includes an input interface device 902 and an output interface device 903 that perform wired communication or wireless communication with a device such as the learning device 2, the control center 3, the web server 4, the sensor 5, or the vehicle 6. The communication unit (not illustrated) uses the input interface device 902 and the output interface device 903.

The learning device 2 according to the first embodiment will be described.

The learning device 2 generates a machine learning model used when the dynamic map generation device 1 generates a dynamic map. In the first embodiment, it is assumed that the learning device 2 generates the machine learning model at a predetermined cycle such as once a day.

As illustrated in FIG. 1, the learning device 2 includes a learning data acquisition unit 21, a model generation unit 22, and a model storage unit 23.

The learning data acquisition unit 21 includes a learning data generation unit 211.

The learning data acquisition unit 21 acquires learning data generated on the basis of dynamic map generation information and having a deficiency-related value related to deficient dynamic information as teacher data among pieces of dynamic information included in the dynamic map generation information.

In the first embodiment, the learning data generation unit 211 of the learning data acquisition unit 21 generates the learning data on the basis of the dynamic map generation information stored in the past information storage unit 18. Note that, in the first embodiment, it is assumed that the past information storage unit 18 stores the dynamic map generation information for a certain period.

First, the learning data generation unit 211 determines dynamic information assumed to be deficient dynamic information on the basis of the type of deficient dynamic information related to a deficiency-related value to be output by a machine learning model for generation of which learning data to be generated is used.

For example, when generating learning data for generating a machine learning model that outputs a deficiency-related value related to surrounding vehicle information, the learning data generation unit 211 determines the surrounding vehicle information as dynamic information assumed to be deficient dynamic information.

Then, the learning data generation unit 211 generates, on the basis of the dynamic map generation information, learning data including dynamic information (“correlation dynamic information”) or static information (correlation static information) correlated with the deficient dynamic information among the pieces of dynamic information and the pieces of static information included in the dynamic map generation information acquired within a preset period (hereinafter, referred to as “learning period”), the dynamic information of the same type as the deficient dynamic information included in the dynamic map generation information acquired within the learning period (dynamic history information), and teacher data. Note that, here, the deficient dynamic information is dynamic information assumed to be deficient dynamic information.

Therefore, in the above example, the learning data generation unit 211 generates, on the basis of the dynamic map generation information, learning data including correlation dynamic information or correlation static information of surrounding vehicle information, acquired within the learning period, dynamic history information of the surrounding vehicle information assumed to be deficient dynamic information, acquired within the learning period, and a deficiency-related value of the surrounding vehicle information assumed to be deficient dynamic information.

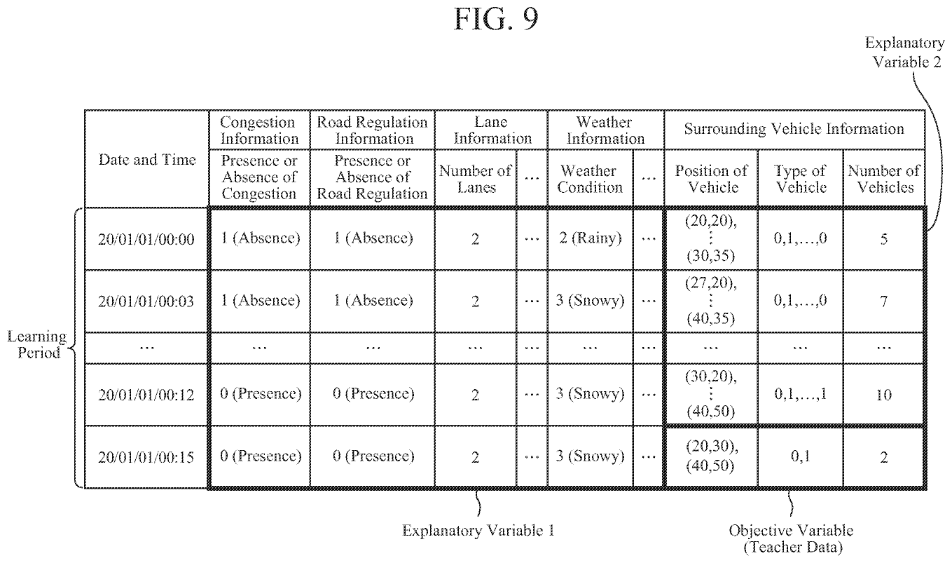

Here, FIG. 9 is a diagram for explaining an example of learning data generated by the learning data generation unit 211 in the first embodiment.

FIG. 9 illustrates an example of learning data when surrounding vehicle information is assumed to be deficient dynamic information. Surrounding vehicle information acquired at 20/01/01/00:15 is assumed to be deficient dynamic information.

In addition, the correlation dynamic information or the correlation static information of the surrounding vehicle information is congestion information, road regulation information, lane information, or weather information.

The learning data generation unit 211 generates learning data including congestion information, road regulation information, lane information, and weather information acquired during a period from 20/01/01/00:00 to 20/01/01/00:15, past surrounding vehicle information acquired during a period from 20/01/01/00:00 to 20/01/01/00:12, and a deficiency-related value of the surrounding vehicle information acquired at 20/01/01/00:15. Note that, here, the surrounding vehicle information is represented by a numerical value (see FIG. 3), and the content of the surrounding vehicle information is a deficiency-related value.

That is, the learning data generation unit 211 generates learning data including two explanatory variables of an explanatory variable 1 (congestion information, road regulation information, lane information, and weather information within the learning period) and an explanatory variable 2 (past surrounding vehicle information in the learning period) and an objective variable (latest surrounding vehicle information).

As described above, in the first embodiment, since the learning data is generated from the dynamic map generation information acquired from the past information storage unit 18, the learning data acquisition unit 21 first determines dynamic information assumed to be deficient dynamic information and generates the learning data as described above. This is because the dynamic map generation information stored in the past information storage unit 18 basically includes no deficient dynamic information.

Note that the image of the learning data illustrated in FIG. 9 is merely an example.

The types of the explanatory variable 1, the explanatory variable 2, and the teacher data change depending on the type of dynamic information that is deficient dynamic information. The learning data generation unit 211 generates learning data depending on the type of deficient dynamic information.

As a specific example, when the deficient dynamic information is pedestrian information, the correlation dynamic information or the correlation static information is building position information, weather information, or traffic regulation information.

In this case, the learning data generation unit 211 generates learning data including building position information, weather information, and traffic regulation information acquired within the learning period, past pedestrian information acquired within the learning period, and a deficiency-related value related to the latest pedestrian information.

When the deficient dynamic information is congestion information, the correlation dynamic information or the correlation static information is traffic regulation information, road construction information, accident information, or weather information.

In this case, the learning data generation unit 211 generates learning data including traffic regulation information, road construction information, accident information, and weather information acquired within the learning period, past congestion information acquired within the learning period, and a deficiency-related value related to the latest congestion information.

When the deficient dynamic information is risk information, the correlation dynamic information or the correlation static information is road surface information, accident information, surrounding vehicle information, or weather information.

In this case, the learning data generation unit 211 generates learning data including road surface information, accident information, surrounding vehicle information, and weather information acquired within the learning period, past risk information acquired within the learning period, and a deficiency-related value related to the latest risk information.

In the first embodiment, when the dynamic information included in the dynamic map generation information stored in the past information storage unit 18 includes dynamic information to which an interpolation flag is added, the learning data generation unit 211 does not have to cause the dynamic information to be included in the learning data.

The learning data generation unit 211 can enhance accuracy of a machine learning model generated on the basis of the learning data by the model generation unit 22 (details will be described later) by excluding information that is not dynamic map generation information actually acquired from the sensor 5 or the like.

When acquiring the learning data generated by the learning data generation unit 211, the learning data acquisition unit 21 outputs the learning data to the model generation unit 22.

The model generation unit 22 generates, on the basis of the learning data acquired by the learning data acquisition unit 21, a machine learning model that receives, as an input, the dynamic map generation information and outputs a deficiency-related value related to the deficient dynamic information.

Specifically, the model generation unit 22 generates, on the basis of the learning data acquired by the learning data acquisition unit 21, a machine learning model that receives, as inputs, the correlation dynamic information or the correlation static information acquired within the learning period and the dynamic information of the same type as the deficient dynamic information acquired within the learning period and outputs a deficiency-related value related to the deficient dynamic information.

The model generation unit 22 generates a machine learning model for each type of deficient dynamic information. The model generation unit 22 can determine, from the learning data, what machine learning model should be generated on the basis of which type of deficient dynamic information corresponds.

The model generation unit 22 stores the generated machine learning model in the model storage unit 23. Note that the model generation unit 22 stores the machine learning model in association with information capable of specifying which type of deficient dynamic information the machine learning model corresponds to.

The model storage unit 23 stores the machine learning model.

Note that, in the first embodiment, the model storage unit 23 is included in the learning device 2, but this is merely an example. The model storage unit 23 may be disposed in a place that can be referred to by the learning device 2 outside the learning device 2.

An operation of the learning device 2 according to the first embodiment will be described.

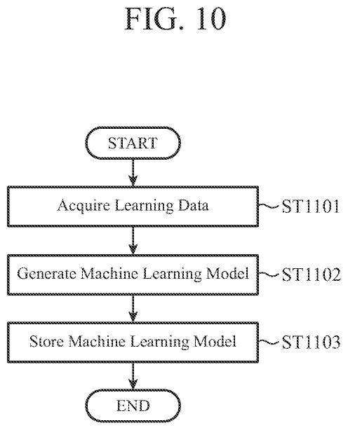

FIG. 10 is a flowchart for explaining an operation of the learning device 2 according to the first embodiment.

The learning data acquisition unit 21 acquires learning data generated on the basis of the dynamic map generation information and having a deficiency-related value related to deficient dynamic information as teacher data among a plurality of types of dynamic information of the dynamic map generation information (step ST1101).

Specifically, the learning data generation unit 211 of the learning data acquisition unit 21 generates the learning data on the basis of the dynamic map generation information stored in the past information storage unit 18. The learning data acquisition unit 21 acquires the learning data generated by the learning data generation unit 211.

When acquiring the learning data generated by the learning data generation unit 211, the learning data acquisition unit 21 outputs the learning data to the model generation unit 22.

The model generation unit 22 generates, on the basis of the learning data acquired in step ST1101 by the learning data acquisition unit 21, a machine learning model that receives, as an input, the dynamic map generation information and outputs a deficiency-related value related to the deficient dynamic information (step ST1102).

Specifically, the model generation unit 22 generates, on the basis of the learning data acquired by the learning data acquisition unit 21, a machine learning model that receives, as inputs, the correlation dynamic information or the correlation static information acquired within the learning period and the dynamic information of the same type as the deficient dynamic information acquired within the learning period and outputs a deficiency-related value related to the deficient dynamic information.

The model generation unit 22 stores the generated machine learning model in the model storage unit 23 (step ST1103).

As described above, the learning device 2 acquires learning data generated on the basis of the dynamic map generation information including the dynamic information and the static information and having a deficiency-related value related to the deficient dynamic information as teacher data, and generates, on the basis of the acquired learning data, a machine learning model that receives, as an input, the dynamic map generation information and outputs the deficiency-related value. As a result, the learning device 2 can generate a machine learning model used for generating a dynamic map having dynamic information interpolated even when the dynamic information is not normally acquired in the dynamic map generation device 1. The learning device 2 can generate a machine learning model that receives correlation dynamic information or correlation static information having various combinations as inputs of the machine learning model, and outputs various deficiency-related values. In addition, since the learning device 2 generates a machine learning model that receives, as an input, correlation dynamic information or correlation static information in addition to a past history of the deficient dynamic information and outputs a deficiency-related value, for example, the dynamic map generation device 1 that estimates a deficiency-related value using the machine learning model can estimate the deficiency-related value more accurately than estimating the deficiency-related value simply from the past history of the deficient dynamic information.

A hardware configuration example of the learning device 2 according to the first embodiment will be described.

Since the hardware configuration example of the learning device 2 according to the first embodiment is similar to the hardware configuration example of the dynamic map generation device 1 according to the first embodiment illustrated in FIGS. 8A and 8B, illustration thereof is omitted.

In the first embodiment, functions of the learning data acquisition unit 21 and the model generation unit 22 are implemented by the processing circuit 901. That is, the learning device 2 includes the processing circuit 901 for performing control to generate a machine learning model used when the dynamic map generation device 1 generates a dynamic map.

The processing circuit 901 may be dedicated hardware as illustrated in FIG. 8A or the central processing unit (CPU) 904 that executes a program stored in the memory 905 as illustrated in FIG. 8B.

When the processing circuit 901 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 901.

In a case where the processing circuit 901 is the CPU 904, the functions of the learning data acquisition unit 21 and the model generation unit 22 are implemented by software, firmware, or a combination of software and firmware. The software or firmware is described as a program and stored in the memory 905. The processing circuit 901 executes the functions of the learning data acquisition unit 21 and the model generation unit 22 by reading and executing the program stored in the memory 905. That is, the learning device 2 includes the memory 905 for storing a program that causes steps ST1101 to ST1103 illustrated in FIG. 10 described above to be executed as a result when the program is executed by the processing circuit 901. It can also be said that the program stored in the memory 905 causes a computer to execute procedures or methods performed by the learning data acquisition unit 21 and the model generation unit 22. Here, for example, a nonvolatile or volatile semiconductor memory such as a RAM, read only memory (ROM), flash memory, erasable programmable read only memory (EPROM), or electrically erasable programmable read-only memory (EEPROM), a magnetic disk, a flexible disk, an optical disc, a compact disc, a mini disc, or a digital versatile disc (DVD) corresponds to the memory 905.

Note that some of the functions of the learning data acquisition unit 21 and the model generation unit 22 may be implemented by dedicated hardware, and some of the functions may be implemented by software or firmware. For example, the function of the learning data acquisition unit 21 can be implemented by the processing circuit 901 as dedicated hardware, and the function of the model generation unit 22 can be implemented by the processing circuit 901 reading and executing a program stored in the memory 905.

The model storage unit 23 uses the memory 905. Note that this is an example, and the model storage unit 23 may be constituted by an HDD, a solid state drive (SSD), a DVD, or the like.

In addition, the learning device 2 includes the input interface device 902 and the output interface device 903 that perform wired communication or wireless communication with a device such as the dynamic map generation device 1.

In the first embodiment described above, the dynamic map is already present, but this is merely an example. The dynamic map generation device 1 may generate a new dynamic map.

In addition, in the first embodiment, in the dynamic map generation device 1, the inference unit 13 infers a deficiency-related value related to the deficient dynamic information on the basis of the correlation dynamic information or the correlation static information among the pieces of dynamic information and the pieces of static information included in the dynamic map generation information acquired by the information acquisition unit 11 within the inference period, the dynamic history information acquired by the information acquisition unit 11 within the inference period, and the machine learning model. It is not limited to this, and for example, when there is not the correlation dynamic information or the correlation static information among the pieces of dynamic information and the pieces of static information included in the dynamic map generation information, the inference unit 13 only needs to infer a deficiency-related value related to the deficient dynamic information on the basis of the dynamic history information acquired within the inference period and the machine learning model. Note that, in this case, the machine learning model is a machine learning model that receives, as an input, the dynamic history information acquired by the information acquisition unit 11 within the inference period and outputs a deficiency-related value related to the deficient dynamic information.

In addition, in the first embodiment, the model generation unit 22 in the learning device 2 generates a machine learning model that receives, as inputs, the correlation dynamic information or the correlation static information among the pieces of dynamic information and the pieces of static information included in the dynamic map generation information acquired within the learning period and the dynamic history information acquired within the learning period, and outputs a deficiency-related value related to the deficient dynamic information. It is not limited to this, and for example, when there is not the correlation dynamic information or the correlation static information among the pieces of dynamic information and the pieces of static information included in the dynamic map generation information, the model generation unit 22 generates a machine learning model that receives, as an input, the dynamic history information acquired within the learning period and outputs a deficiency-related value.

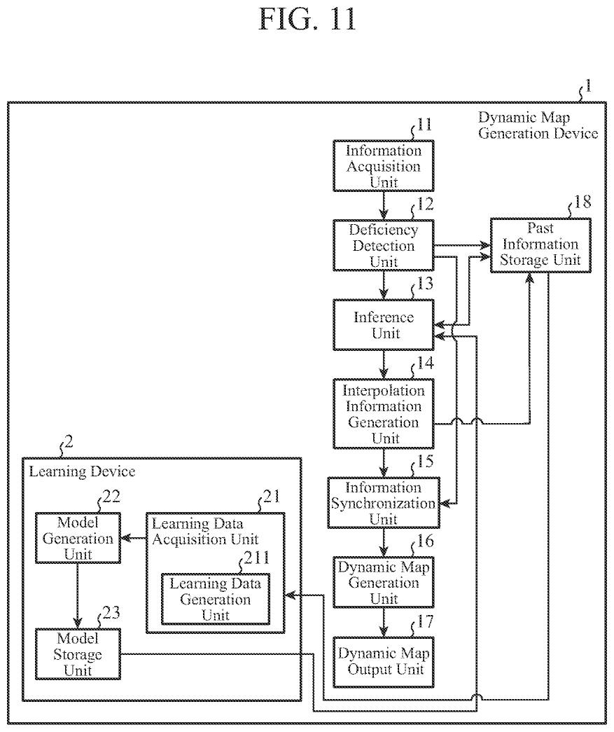

In addition, in the first embodiment described above, it is assumed that the learning device 2 is mounted on a server different from the server of the dynamic map generation device 1, but this is merely an example. The learning device 2 may be mounted on the same server as that of the dynamic map generation device 1. In addition, the learning device 2 may be mounted on the dynamic map generation device 1 (see FIG. 11).

In addition, in the first embodiment described above, in the learning device 2, the learning data generation unit 211 generates learning data, but this is merely an example. For example, an administrator or the like may generate learning data in advance on the basis of the dynamic information and the static information. In this case, the learning device 2 does not have to include the learning data generation unit 211.

As described above, according to the first embodiment, the dynamic map generation device 1 includes: the information acquisition unit 11 that acquires dynamic map generation information including a plurality of types of dynamic information having a high reflection frequency in a dynamic map and a plurality of types of static information having a lower reflection frequency than the dynamic information; the deficiency detection unit 12 that detects whether or not there is deficient dynamic information or static information among the plurality of types of dynamic information or the plurality of types of static information in the dynamic map generation information acquired by the information acquisition unit 11; the inference unit 13 that infers a deficiency-related value related to deficient dynamic information on the basis of the dynamic map generation information acquired by the information acquisition unit 11 and a machine learning model when the deficiency detection unit 12 detects that there is the deficient dynamic information that is deficient among the plurality of types of dynamic information; the interpolation information generation unit 14 that generates deficiency interpolation information corresponding to the deficient dynamic information on the basis of the deficiency-related value inferred by the inference unit 13; the information synchronization unit 15 that synchronizes the deficiency interpolation information generated by the interpolation information generation unit 14 with the dynamic map generation information in which the deficient dynamic information is deficient; and the dynamic map generation unit 16 that generates the dynamic map on the basis of the dynamic map generation information synchronized by the information synchronization unit 15.

Therefore, even when dynamic information is not normally acquired, the dynamic map generation device 1 can generate a dynamic map having the dynamic information interpolated.

In addition, in the dynamic map generation device 1, the inference unit 13 infers a deficiency-related value on the basis of dynamic information or static information correlated with deficient dynamic information among a plurality of types of dynamic information and a plurality of types of static information included in the dynamic map generation information acquired by the information acquisition unit 11 within the inference period, the dynamic information of the same type as the deficient dynamic information included in the dynamic map generation information acquired by the information acquisition unit within the inference period, and the machine learning model.

Therefore, since the dynamic map generation device 1 estimates a deficiency-related value on the basis of the correlation dynamic information or the correlation static information in addition to a past history of the deficient dynamic information, for example, the dynamic map generation device 1 can estimate the deficiency-related value more accurately than estimating the deficiency-related value simply from the past history of the deficient dynamic information.

In addition, according to the first embodiment, the learning device 2 includes: the learning data acquisition unit 21 that acquires learning data generated on the basis of dynamic map generation information including a plurality of types of dynamic information having a high reflection frequency in a dynamic map and a plurality of types of static information having a lower reflection frequency than the dynamic information, and having a deficiency-related value related to deficient dynamic information that is deficient as teacher data among the plurality of types of dynamic information of the dynamic map generation information; and the model generation unit 22 that generates, on the basis of the learning data acquired by the learning data acquisition unit 21, a machine learning model that receives, as an input, the dynamic map generation information and outputs the deficiency-related value.

Therefore, the learning device 2 can generate a machine learning model used for generating a dynamic map having dynamic information interpolated even when the dynamic information is not normally acquired in the dynamic map generation device 1.

In addition, in the learning device 2, the learning data includes: dynamic information or static information correlated with deficient dynamic information among a plurality of types of dynamic information and a plurality of types of static information included in the dynamic map generation information acquired within the learning period; the dynamic information of the same type as the deficient dynamic information included in the dynamic map generation information acquired within the learning period; and teacher data, and the model generation unit 22 generates, on the basis of the learning data, a machine learning model that receives, as inputs, the dynamic information or the static information correlated with the deficient dynamic information acquired within the learning period and the dynamic information of the same type as the deficient dynamic information acquired within the learning period, and outputs a deficiency-related value.

Since the learning device 2 generates a machine learning model that receives, as an input, correlation dynamic information or correlation static information in addition to a past history of the deficient dynamic information and outputs a deficiency-related value, for example, the dynamic map generation device 1 that estimates a deficiency-related value using the machine learning model can estimate the deficiency-related value more accurately than estimating the deficiency-related value simply from the past history of the deficient dynamic information.

Note that any component in the embodiment can be modified, or any component in the embodiment can be omitted.

### INDUSTRIAL APPLICABILITY

Even when dynamic information is not normally acquired for a dynamic map referred to in automatic operating control, the dynamic map generation device according to the present disclosure can generate the dynamic map associated with the dynamic information.

### REFERENCE SIGNS LIST

1: dynamic map generation device, 11: information acquisition unit, 12: deficiency detection unit, 13: inference unit, 14: interpolation information generation unit, 15: information synchronization unit, 16: dynamic map generation unit, 17: dynamic map output unit, 18: past information storage unit, 2: learning device, 21: learning data acquisition unit, 211: learning data generation unit, 22: model generation unit, 23: model storage unit, 3: control center, 4: web server, 5: sensor, 6: vehicle, 901: processing circuit, 902: input interface device, 903: output interface device, 904: CPU, 905: memory

1. A dynamic map generation device comprising:
processing circuitry configured to
acquire dynamic map generation information including a plurality of types of dynamic information having a high reflection frequency in a dynamic map and a plurality of types of static information having a lower reflection frequency than the dynamic information;
detect whether or not there is deficient dynamic information or static information among the plurality of types of dynamic information or the plurality of types of static information in the acquired dynamic map generation information;
infer a deficiency-related value related to deficient dynamic information on a basis of the acquired dynamic map generation information and a machine learning model when it is detected that there is the deficient dynamic information that is deficient among the plurality of types of dynamic information;
generate deficiency interpolation information corresponding to the deficient dynamic information on a basis of the inferred deficiency-related value;
synchronize the generated deficiency interpolation information with the dynamic map generation information in which the deficient dynamic information is deficient; and
generate the dynamic map on a basis of the synchronized dynamic map generation information.

2. The dynamic map generation device according to claim 1, wherein
the processing circuitry is configured to
infers the deficiency-related value on a basis of the dynamic information or the static information correlated with the deficient dynamic information among the plurality of types of dynamic information and the plurality of types of static information included in the acquired dynamic map generation information within an inference period, the dynamic information of the same type as the deficient dynamic information included in the acquired dynamic map generation information within the inference period, and the machine learning model.

3. The dynamic map generation device according to claim 1, wherein
the processing circuitry is configured to
infers the deficiency-related value on a basis of the dynamic information of the same type as the deficient dynamic information included in the acquired dynamic map generation information within an inference period, and the machine learning model.

4. The dynamic map generation device according to claim 1, comprising
wherein the processing circuitry is configured to
generate the machine learning model that receives, as an input, the dynamic map generation information and outputs the deficiency-related value.

5. The dynamic map generation device according to claim 4, wherein
wherein the processing circuitry is configured to
generates the machine learning model on a basis of the acquired dynamic map generation information within a learning period.

6. The dynamic map generation device according to claim 5, wherein
when the acquired dynamic map generation information within the learning period includes the dynamic map generation information including the deficient dynamic information, the processing circuitry removes the dynamic map generation information including the deficient dynamic information from the dynamic map generation information used to generate the machine learning model.

7. A learning device to generate a machine learning model used for generating a dynamic map based on dynamic map generation information, the learning device comprising:
processing circuitry configured to
acquire learning data generated on a basis of the dynamic map generation information including a plurality of types of dynamic information having a high reflection frequency in the dynamic map and a plurality of types of static information having a lower reflection frequency than the dynamic information, and having a deficiency-related value related to deficient dynamic information that is deficient as teacher data among the plurality of types of dynamic information of the dynamic map generation information; and
generate, on a basis of the acquired learning data, the machine learning model that receives, as an input, the dynamic map generation information and outputs the deficiency-related value.

8. The learning device according to claim 7, wherein
the learning data includes: the dynamic information or the static information correlated with the deficient dynamic information among the plurality of types of dynamic information and the plurality of types of static information included in the dynamic map generation information acquired within a learning period; the dynamic information of the same type as the deficient dynamic information included in the dynamic map generation information acquired within the learning period; and the teacher data, and
the processing circuitry generates, on a basis of the learning data, the machine learning model that receives, as inputs, the dynamic information or the static information correlated with the deficient dynamic information acquired within the learning period and the dynamic information of the same type as the deficient dynamic information acquired within the learning period, and outputs the deficiency-related value.

9. The learning device according to claim 8, wherein
the deficient dynamic information is surrounding vehicle information, and
the dynamic information or the static information correlated with the deficient dynamic information is congestion information, road surface information, lane information, or weather information.

10. The learning device according to claim 8, wherein
the deficient dynamic information is pedestrian information, and
the dynamic information or the static information correlated with the deficient dynamic information is building position information, weather information, or traffic regulation information.

11. The learning device according to claim 8, wherein
the deficient dynamic information is congestion information, and
the dynamic information or the static information correlated with the deficient dynamic information is traffic regulation information, road construction information, accident information, or weather information.

12. The learning device according to claim 8, wherein
the deficient dynamic information is risk information indicating a possibility that a vehicle falls into an unexpected situation, and
the dynamic information or the static information correlated with the deficient dynamic information is road surface information, accident information, surrounding vehicle information, or weather information.

13. The learning device according to claim 7, wherein
the learning data includes: the dynamic information of the same type as the deficient dynamic information included in the dynamic map generation information acquired within the learning period; and the teacher data, and
the processing circuitry generates, on a basis of the learning data, the machine learning model that receives, as an input, the dynamic information of the same type as the deficient dynamic information acquired within the learning period, and outputs the deficiency-related value.

14. A dynamic map generation method comprising:
acquiring dynamic map generation information including a plurality of types of dynamic information having a high reflection frequency in a dynamic map and a plurality of types of static information having a lower reflection frequency than the dynamic information;
detecting whether or not there is deficient dynamic information or static information among the plurality of types of dynamic information or the plurality of types of static information in the acquired dynamic map generation information;
inferring a deficiency-related value related to deficient dynamic information on a basis of the acquired dynamic map generation information and a machine learning model when the it is detected that there is the deficient dynamic information that is deficient among the plurality of types of dynamic information;
generating deficiency interpolation information corresponding to the deficient dynamic information on a basis of the inferred deficiency-related value;
synchronizing the generated deficiency interpolation information with the dynamic map generation information in which the deficient dynamic information is deficient; and
generating the dynamic map on a basis of the synchronized dynamic map generation information.

15. A learning method for generating a machine learning model used for generating a dynamic map based on dynamic map generation information, the learning method comprising:
acquiring learning data generated on a basis of the dynamic map generation information including a plurality of types of dynamic information having a high reflection frequency in the dynamic map and a plurality of types of static information having a lower reflection frequency than the dynamic information, and having a deficiency-related value related to deficient dynamic information that is deficient as teacher data among the plurality of types of dynamic information of the dynamic map generation information; and
generating, on a basis of the acquired learning data, the machine learning model that receives, as an input, the dynamic map generation information and outputs the deficiency-related value.
